(19) United States
(12) Patent Application Publication
(10) Pub. No.: US 2018/0182566 A1
(43) Pub. Date: Jun. 28, 2018

(54) METHOD FOR PREPARING A COMPOSITE ELECTRODE

(71) Applicants: CENTRE NATIONAL DE LA RECHERCHE SCIENTIFIQUE, PARIS (FR); UNIVERSITE DE NANTES, NANTES (FR)

(72) Inventors: Thierry BROUSSE, LA CHAPELLE SUR ERDRE (FR); Laurence ATHOUËL, NANTES (FR); Grégory POGNON, VILLEJUIF (FR)

(21) Appl. No.: 15/738,673

(22) PCT Filed: Jun. 22, 2016
(86) PCT No.: PCT/FR2016/000100

§ 371 Date: Dec. 21, 2017

(30) Foreign Application Priority Data
Jun. 23, 2015 (FR) 1555771

(51) Int. Cl. H01G 11/86; H01M 4/60; H01M 4/04; H01M 4/62; H01M 4/36; H01G 11/32; H01G 11/66; C09D 5/24; C09D 7/40; C09D 7/62; C09D 129/04; C09D 7/61

(52) U.S. Cl. CPC H01G 11/86; H01M 4/60; H01M 4/0404; H01M 4/0471; H01M 4/625; H01M 4/364; C08K 7/06; H01G 11/66; C09D 5/24; C09D 7/70; C09D 7/62; C09D 129/04; C09D 7/61; H01G 11/32

(57) ABSTRACT

The invention relates to a method for preparing a composite electrode comprising a composite material deposited on a current collector, notably on a pliable and flexible collector, to said composite electrode, to the uses thereof and to an electrochemical storage system comprising said composite electrode.

The invention relates to a method for preparing a composite electrode comprising a composite material deposited on a current collector, notably on a collector that is pliable and flexible, to said composite electrode, the uses thereof and an electrochemical storage system comprising said composite electrode.

Existing electrochemical storage devices comprise fuel cells, batteries, supercapacitors and capacitors. Batteries are characterized by a high energy density, capable of supplying an electrical system over a period, but have the disadvantage of moderate power, whereas capacitors have a very low energy density, but retain the advantage of high power. In contrast to batteries, capacitors deliver very high power cyclically but the associated energy density is very low. As an example of electrochemical batteries, we may mention lithium-ion technology, which is already used in a great many new-generation vehicles. On the other hand, supercapacitors, with lower capacity, are used as energy converters. They are already used in means of transport or lifting equipment for converting kinetic or potential energy into electrical energy. They also equip electric or hybrid vehicles, where they are used for recovery of the energy of braking, supplementing a battery or a fuel cell.

At least one of the electrodes used in these electrochemical storage devices generally consists of a film or a paste of composite material deposited on a metallic current collector, said composite material comprising at least one active electrode material, optionally a material generating electron conduction and optionally a polymer binder. The active electrode material is used in the form of particles, and it may be for example a transition metal oxide (e.g. MnO₂, Fe₃O₄), notably with spinel or lamellar structure (e.g. oxides corresponding to the formula LiMPO₄, in which M represents at least one element selected from Mn, Fe, Co and Ni, in particular LiFePO₄) or an activated carbon, notably nanoporous. The material generating electron conductivity is generally carbon, in the form of powdered carbon black, powdered graphite, carbon fibres or carbon nanofibres. The polymer binder used is generally hydrophobic, such as poly(vinylidene fluoride) (PVdF) or polytetrafluoroethylene (PTFE). The film or paste of composite material deposited on a metallic current collector is generally prepared by coating a current collector with an ink comprising the active electrode material, the material generating electron conduction and the polymer binder. The adhesion between the various constituents is therefore essentially mechanical and it only allows coating with small amounts of active material (i.e. from about some hundreds of μg to some mg per cm²), while leading to low mechanical durability of the film or paste on the current collector during deformation, or even to zero durability when the current collector is a material that is pliable or flexible, such as a textile material, a carbon fabric or a glass fabric. Poor adhesion of the active material in the composite electrode also leads to deterioration of electrochemical performance, notably in terms of cycling stability. Furthermore, the active material in the electrode obtained has limited ionic and electronic accessibility to the polar organic or aqueous liquid electrolyte, notably when it is present in large amounts.

To improve the performance of electrochemical storage systems, many research teams have concentrated on the preparation of new electrode materials and/or the synthesis or formulation of new electrolytes.

In particular, patent EP 2 417 657 B1 describes a method for preparing a composite electrode comprising a mixture of functionalized particles of active material and functionalized particles of a material generating electron conductivity, said mixture being supported by a metallic current collector, optionally functionalized. The method comprises steps of functionalization of the particles of active material and particles of material generating electron conductivity with suitable chemical groups, so that said particles can bind together covalently or electrostatically, and optionally a step of functionalization of the metallic current collector with suitable chemical groups so that the particles of active material can bind to the metallic current collector covalently or electrostatically. The functionalization of the material generating electron conductivity may be performed by formation in situ of a diazonium salt R¹—N⁺═N.X⁻ comprising a positively charged azo function —N⁺═N associated with a negatively charged counter-anion X⁻, said azo function being quite easily reducible, and leading to the formation of a very reactive aryl radical R^{1.}. This radical R^{1.} can then be grafted by covalent bonding onto said material generating electron conductivity. The diazonium salts may be obtained from aromatic amines having many functional groups (—CO₂H, —NO₂, —Br, —OH) in the para position of the amine function. They may also allow functionalization of the metallic current collector. As an example, a mixture of carbon fibres and carbon nanotubes as the material generating electron conductivity is functionalized with groups of the type -Ph-CH₂—CO₂H starting from 4-aminophenylacetic acid as the aromatic amine. Furthermore, titanium oxide as the active electrode material is functionalized with groups of the type —CO₂—CH₂-Ph-NH₂. Then the particles of active material and of material generating electron conductivity are brought into contact in the presence of a coupling agent such as 4-(4,6-dimethoxy-1,3,5-triazin-2-yl)-4-methylmorpholinium chloride (DMTMM) in order to bind said particles covalently (via formation of an amide function). The electrochemical performance of the composite electrode obtained is not described. Moreover, functionalization of the active material may cause a decrease in the amount of active material available for providing the ion and electron exchanges in the electrochemical storage device and alteration of its physical properties (e.g. its wettability, adherence to a polymer binder, extrudability, etc.). Therefore the electrochemical performance of said device is not optimized.

Moreover, surface modification of a carbon-containing agent, notably carbon nanotubes, with any type of hydrophobic or hydrophilic polymer has been investigated extensively for allowing homogeneous dispersion and/or dissolution in various liquid media and thus for fabricating nanocomposite films. One of the methods most commonly used consists of functionalizing a carbon-containing agent (e.g. carbon nanotubes) with a polymerization initiator (e.g. α-bromoisobutyryl bromide), and then carrying out polymerization (e.g. poly(methyl methacrylate)). This method makes it possible to obtain a high degree of grafting. However, it is difficult to control the molecular weight of the grafted polymer, there is a limited choice of polymers that can be grafted, and by-products may be formed, notably in the case of radical polymerization. Another method consists of forming the polymer first, then secondly grafting it on the “bare” carbon-containing agent or after surface oxidation of the latter (e.g. treatment in an acid medium). This method allows total control of the molecular weight of the grafted polymer. However, it generally leads to very low degrees of grafting (below 1%), notably connected with steric hindrance of the polymer chains and/or with low reactivity of the carbon-containing agent after surface oxidation. Moreover, this method employs relatively harsh reaction conditions (high temperatures and/or long reaction times), which may be incompatible with the molecules that are to be grafted on the carbon-containing agent. As an example, Lin et al. [Macromolecules, 2003, 36, 19, 7199-7204] describe the functionalization of carbon nanotubes previously treated in an acid medium in order to have carboxylic functions on the surface, with polyvinyl alcohol (PVA) by an esterification reaction. Films about 50 to 200 μm thick were obtained by mixing the solution of functionalized carbon nanotubes with PVA in a viscous matrix of pure PVA. However, the presence of the ester functions was not detected by carbon NMR, the degree of grafting is low (i.e. about 4%) and the content of carbon nanotubes in the film is not sufficient (0.1-3 wt %) to ensure good electron conduction.

Other more promising methods involve the addition of polymer radicals or of anionic polymers on the surface of a carbon-containing agent comprising π bonds (carbon nanotubes) since they avoid prior functionalization of the carbon-containing surface.

The aim of the present invention is to overcome the drawbacks of the aforementioned prior art and supply a simple and economical method for preparing a composite electrode comprising a composite material deposited on a current collector (i.e. a supported composite electrode), said method making it possible to immobilize small or large amounts of active material in pulverulent form in the composite electrode, while optimizing its ionic and electronic accessibility and its mechanical durability, notably when the electrode is used in an electrochemical storage device.

Another aim of the invention is to supply a composite electrode having improved mechanical durability, while guaranteeing good electrochemical performance, notably in terms of cycling stability and specific capacitance.

These aims are achieved by the invention that will be described below.

Therefore a first object of the invention is a method for preparing a composite electrode comprising a composite material deposited on an optionally functionalized current collector CC, said method comprising:

1) a step of functionalization of a carbon-containing agent CE with any one of the following functional groups L: carboxylic acid [—CO₂M], acyl halide [—COX], acid anhydride [—C(═O)OC(═O)—], sulphonic acid [—SO₂(OM)], sulphonic acid halide [—SO₂X], phosphonic acid dihalide [—POX₂], monoester halide of phosphonic acid [—POX(OR)], monoester of phosphonic acid [—PO(OR)(OM)], diester of phosphonic acid [—PO(OR)₂] or isocyanate [—N═C═O], with X representing a chlorine atom or a bromine atom, M representing a proton, an alkali metal cation or an organic cation and R representing a methyl or ethyl group, in order to form a functionalized carbon-containing agent CE-f, and

said method being characterized in that it further comprises the following steps:

2) a step of preparing an aqueous or organic paste comprising the functionalized carbon-containing agent CE-f from step 1), at least one active material MA and at least one hydrophilic polymer PH comprising several alcohol functions, and

3) a step comprising bringing the aqueous or organic paste into contact with an optionally functionalized current collector CC and thermal treatment of the aqueous or organic paste and of the optionally functionalized current collector CC, in order to form a composite electrode comprising a composite material deposited on said current collector CC,

it being understood that:
said optionally functionalized current collector CC has a surface resistance less than or equal to about 50 ohms per 1 cm² of surface area (i.e. less than or equal to about 50 ohms/square centimetre or Ω/cm²), and
said composite material comprises a functionalized carbon-containing agent CE-f, at least one active material MA and at least one crosslinked hydrophilic polymer PH-r comprising several alcohol functions and several ester functions selected from esters of carboxylic acids, esters of phosphonic acids, esters of sulphonic acids and carbamates, said crosslinked hydrophilic polymer PH-r being bound covalently to the functionalized carbon-containing agent CE-f via said ester functions.

The hydrophilic polymer PH may further comprise several hydrophilic functions different from the alcohol functions. The hydrophilic functions different from the alcohol functions may be selected from the carboxylic acid, amine, and ketone functions and a mixture thereof.

Owing to the method of the invention, the active material MA is immobilized in the composite electrode. In particular, the MA is held in the composite material owing to the formation of numerous covalent bonds between the functionalized carbon-containing agent CE-f and the crosslinked hydrophilic polymer PH-r. Said composite material therefore represents a carbon-polymer hybrid matrix ensuring uniform distribution and holding of the active material, which may be in the form of nanometric and/or micrometric particles. Furthermore, the method makes it possible to deposit an active material MA on a pliable or rigid current collector CC, having a large surface area (about several hundred cm²) and/or in the form of a relatively thick film (i.e. from about 50 μm to 1 mm). Consequently, any active material MA initially in the form of powder may thus be deposited on the current collector CC in large amounts and reproducibly, while guaranteeing good accessibility, both electronic and ionic, good mechanical durability of the composite electrode, as well as good electrochemical performance, notably in an aqueous medium and in a polar organic medium.

Furthermore, when the current collector is functionalized, true anchoring of the carbon-polymer hybrid matrix, comprising the active electrode material MA, on the surface of the current collector CC is then obtained owing to the presence of additional covalent bonds between the functionalized current collector CC-f and the crosslinked hydrophilic polymer PH-r of the composite material.

Step 1): Preparation of the Functionalized Carbon-Containing Agent

The carbon-containing agent CE used in step 1) performs the role of an agent generating electron conduction in the composite material.

The carbon-containing agent CE may be selected from a carbon black, a graphite, a graphene, an SP carbon, an acetylene black, a vitreous carbon, carbon nanotubes, carbon fibres, carbon nanofibres and a mixture thereof.

Carbon nanofibres are preferred.

In the present invention, the carbon nanotubes comprise both single-wall carbon nanotubes (SWNTs) comprising a single graphene sheet and multiwall carbon nanotubes (MWNTs) comprising several graphene sheets fitted in one another in the manner of Russian dolls, or else a single graphene sheet wound on itself several times.

In a particular embodiment, the carbon nanotubes have an average diameter ranging from about 1 to 50 nm.

Carbon fibres are materials comprising very fine fibres with a diameter from about 5 to 15 μm in which carbon is the main chemical element. Other atoms are generally present, such as oxygen, nitrogen, hydrogen, and less often sulphur. The carbon atoms are joined together and form crystals of the graphitic type, more or less parallel to the axis of the fibre.

Carbon nanofibres (or carbon fibrils or carbon nanowires) are made up of graphitic zones that are more or less organized (or turbostratic stacks), the planes of which are inclined at variable angles to the axis of the fibre. These stacks may assume the form of platelets, fish bones or stacked dishes to form structures having a diameter generally from about 100 nm to 500 nm, or even more.

As examples of carbon nanofibres, we may mention vapour grown carbon fibres (VGCFs), notably those having a diameter of about 100 nm and a length ranging from about 20 to 200 μm.

When M is an organic cation in the functional groups L, it may be selected from the oxonium, ammonium, quaternary ammonium, amidinium, guanidinium, pyridinium, morpholinium, pyrrolidionium, imidazolium, imidazolinium, triazolium, sulphonium, phosphonium, iodonium and carbonium groups.

When M is an alkali metal cation in the functional groups L, it is preferably lithium, sodium or potassium.

According to a first variant of step 1), the functional group L as defined in the invention is grafted directly on the carbon-containing agent CE.

This variant is particularly suitable when the functional group L is any one of the following groups: —CO₂M, —SO₂(OM) or —PO(OM)₂.

Step 1) may be performed by controlled oxidation of CE when L is —CO₂M, by reaction of CE with SO₃ when L is —SO₃M or by reaction of CE with PCl₃ followed by hydrolysis when L is —PO(OM)₂.

In particular, grafting of the —CO₂M functional group may be performed by one of the following methods:
oxidation of CE by CO₂ at a temperature of about 500° C.-900° C., or
treatment of CE with cold plasma under CO₂.

According to a second variant of step 1), the functional group L as defined in the invention is grafted on the carbon-containing agent CE via a compound bearing said functional group.

In particular, grafting of the —CO₂M functional group may be performed by one of the following methods:
diazotization of CE by a compound bearing a —CO₂H group,
reaction of CE with maleic anhydride, followed by hydrolysis;
Diels-Alder addition reaction of CE with an acid containing a —C═C— or —C≡C— unsaturated bond, for example with fumaric acid or acetylene dicarboxylic acid (HCO₂—C≡C—CO₂H); or
addition reaction with a compound bearing a —CO₂H group such as a disulphide, a benzotriazole (e.g. benzotriazole-5-carboxylic acid) or an azo compound (e.g. azobenzene-4-carboxylic acid).

In the —CO₂H functional group, the hydrogen atom may then be replaced by methods of cation exchange that are within the capability of a person skilled in the art, to lead to the —CO₂M functional group.

Grafting of the —SO₃M functional group may be performed by one of the following methods:
reaction of CE with a disulphide bearing two terminal —SO₃M groups (e.g. LiSO₃-Ph-S—S-Ph-SO₃Li);
reaction of CE with a benzotriazole bearing an —SO₃H group (e.g. δ-(1-benzotriazolyl)butanesulphonic acid);
addition reaction with an azo compound bearing sulphonate groups of alkali metal (e.g. (8Z)-7-oxo-8-(phenylhydrazinylidene) also known by the name “orange G”); or
diazotization of CE by a compound bearing an —SO₃H group.

Grafting of the phosphonate functional group may be performed by reactions similar to those that are employed for grafting the sulphonate group, notably using precursors bearing phosphonate groups instead of the sulphonate groups (benzotriazole, azo, —C═C—, —C≡C—, diazonium).

Functionalization step 1) makes it possible to introduce the functional groups L as defined in the invention into the starting carbon-containing agent CE. These functional groups L are then capable of reacting with at least one part of the alcohol functions of a hydrophilic polymer PH comprising several alcohol functions to form covalent bonds via functions (e.g. esters of carboxylic acids, esters of phosphonic acids, esters of sulphonic acids or carbamates). Formation of these covalent bonds leads to crosslinking of the starting hydrophilic polymer PH and thus formation of a hydrophilic polymer PH-r (crosslinked hydrophilic polymer PH) comprising several alcohol functions and several ester functions selected from esters of carboxylic acids, esters of phosphonic acids, esters of sulphonic acids and carbamates.

According to an especially preferred embodiment of the invention, the carbon-containing agent CE is functionalized in step 1) using a reagent T-X-L, in which:
the group T is a functional group capable of reacting with CE to form a covalent bond or a precursor functional group of a functional group capable of reacting with CE to form a covalent bond;
the group X is a conjugated spacer group, i.e. a group that comprises a system of atoms joined by a covalent bond to at least one delocalized bond;
the group L is as defined in the invention.

The conjugated spacer group X may be an aryl group, i.e. an aromatic or heteroaromatic group, mono- or polycyclic, optionally substituted, having from 5 to 20 carbon atoms, notably from 5 to 14 carbon atoms, in particular from 6 to 8 carbon atoms. The heteroatom or heteroatoms that may be present in the aryl group is (are) advantageously selected from the group consisting of N, O, P or S.

In the case of an aromatic or heteroaromatic polycyclic group, each ring may comprise from 3 to 8 carbon atoms.

The spacer group X may also be a divalent group selected from the phenylene, oligophenylene, oligophenylenevinylene, oligophenyleneethynylene, oligothiophene and azobenzene groups.

The group T of a reagent T-X-L depends on the chemical nature of the carbon-containing agent CE, which must be modified during step 1).

The reagent T-X-L may be a diazonium salt or a precursor of a diazonium salt.

In the case when the reagent T-X-L is a diazonium salt, T is a diazonium cation. The counter-ion may be for example a BF₄⁻ or Cl⁻ anion.

The reaction of the carbon-containing agent CE with a reagent T-X-L in which T is a diazonium cation is preferably performed chemically, notably in solution in acetonitrile or in water at pH 2, said solution containing from about 2 to 50 mM of diazonium salt.

In particular, a reagent T-X-L in which T is a diazonium cation may be produced in situ starting from a precursor NH₂—X-L by adding a nitrosation agent such as tert-butyl nitrite [(CH₃)₃CONO or tBu-NO₂] in an organic medium (e.g. acetonitrile) or sodium nitrite (NaNO₂) in an acid medium (e.g. a medium with pH 1).

Generally, the molar ratio of nitrosation agent to NH₂—X-L precursor is in the range from about 1 to 5 and the molar ratio of NH₂—X-L precursor to carbon-containing agent CE is from about 0.1 to 0.5.

Next, formation of the radical .X-L, derived from the diazonium salt T-X-L may be induced in several ways: spontaneously, by UV or microwave radiation, by ultrasound, by thermal treatment or by electrochemistry.

Reaction of the carbon-containing agent CE with a reagent T-X-L in which T is a diazonium cation may also be performed electrochemically in a three-electrode cell, at a potential below 0 V vs SCE (KCl-saturated calomel electrode), in which the electrolyte is a deaerated 0.1 M solution of NEt₄BF₄ or NBu₄BF₄ in acetonitrile, said solution containing from about 0.1 to 50 mM of diazonium salt.

T-X-L is preferably such that L is —CO₂H or —CO₂M and T is —NH₂ (precursor functional group of the diazonium cation N₂⁺).

In particular, the reagent T-X-L may correspond to one of the following formulae:

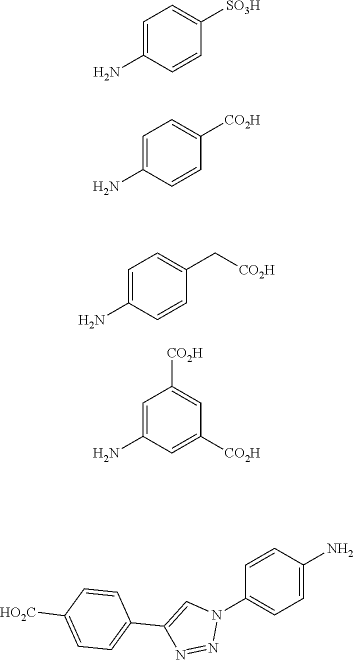

Step 2): Preparation of the Aqueous or Organic Paste

The active material MA may be any type of active electrode material in pulverulent form.

It may be in the form of micrometric and/or nanometric particles, notably in the form of particles with a size in the range from about 10 nm to 10 μm.

The active material may be a positive electrode active material or a negative electrode active material.

It is advantageously selected from oxides, phosphates, borates, activated carbons, graphite, graphene and metal alloys of the type Li_{Y}M in which 1<y<5 and M=Mn, Sn, Pb, Si, In or Ti.

As examples of oxides, we may mention the simple oxides MnO₂, Fe₃O₄, the complex oxides LiₓMn_{y}O₄ in which 0<x<2, 0<y<2 and x+y=3, LiCoO₂, LiAlₓCo_{y}Ni_{z}O₂ in which 0<x<1, 0<y<1, 0<z<1 and x+y+z=1, LiNi_{(1-y)}Co_{y}O₂ in which 0≤y<1, the oxides derived from lithium titanates by partial replacement of Li or of Ti.

As examples of phosphates, we may mention the phosphates of lithium and of at least one transition metal preferably selected from Fe, Mn, Ni and Co such as LiMPO₄ in which M is Fe, Mn, Co or Ni.

As examples of borates, we may mention the borates of Li and of at least one transition metal preferably selected from Fe, Mn and Co.

The activated carbons generally have a specific surface area from about 200 m²/g to about 3000 m²/g.

The amount of active material that can be deposited may reach from about 1 to 25 mg per cm² of collector surface area, and preferably from about 5 to 20 mg per cm² of collector surface area.

The hydrophilic polymer PH comprising several alcohol functions may have a molecular weight from about 5000 g/mol to about 300000 g/mol, and preferably from about 10000 g/mol to about 30000 g/mol.

The hydrophilic polymer PH comprising several alcohol functions may be selected from polysaccharides, oligosaccharides and synthetic polymers comprising [—CH₂—CH(OH)—]ₙ repeating units, with n from about 100 to 7000.

As examples of polysaccharides, we may mention cellulose, pectins, starch, glucoses, inulins, alginates, gelatins, dextrins, agar-agar, glycogen, chitin, and derivatives thereof.

As examples of synthetic polymers, we may mention polyvinyl alcohol, the copolymers of vinyl alcohol such as the copolymers of vinyl alcohol and acrylic acid, the copolymers of vinyl alcohol and methacrylic acid, the copolymers of vinyl alcohol and maleic acid, the copolymers of vinyl alcohol and vinyl ester.

The synthetic polymers are preferred, in particular polyvinyl alcohol.

The paste in step 2) is preferably an aqueous paste.

In a particular embodiment, step 2) is carried out according to the following substeps:

2-i) preparing an aqueous or organic solution comprising from about 0.5 to 30 wt %, and preferably from about 0.5 to 15 wt % of hydrophilic polymer PH,

2-ii) preparing an aqueous or organic suspension comprising from about 0.1 to 10 wt %, and preferably from about 0.5 to 5 wt % of MA; and from about 0.1 to 5 wt %, and preferably from about 0.1 to 1.5 wt % of CE-f,

2-iii) mixing the aqueous or organic suspension from substep 2-ii) with the aqueous or organic solution from substep 2-i), and

2-iv) maintaining the resultant suspension at room temperature or heating, in order to obtain an aqueous or organic paste.

When the solution from substep 2-i) is an organic solution, it preferably comprises from about 0.5 to 5 wt % of hydrophilic polymer PH.

When the solution from substep 2-i) is an aqueous solution, it preferably comprises from about 5 to 15 wt % of hydrophilic polymer PH.

The solution from substep 2-i) is preferably an aqueous solution.

Substep 2-i) may be carried out with stirring and/or by heating the aqueous or organic solution, in order to dissolve the hydrophilic polymer PH in said aqueous or organic solution.

The heating in substep 2-i) may be carried out at a temperature in the range from about 20° C. to 90° C.

The suspension in substep 2-ii) is preferably an aqueous suspension.

Substep 2-ii) may be performed by firstly dispersing the MA, notably using ultrasound, and then secondly dispersing the CE-f, notably using ultrasound.

Substep 2-iii) is preferably carried out by gradually adding the aqueous or organic solution from substep 2-i) to the aqueous or organic suspension from substep 2-ii), with stirring.

Substep 2-iv) of maintenance or heating may take from about 12 h to 48 h.

Substep 2-iv) is generally carried out with stirring.

The heating in substep 2-iv) may be carried out at a temperature in the range from about 70° C. to 90° C., and preferably from about 75° C. to 85° C.

In a preferred embodiment, substep 2-iv) is a heating step.

This substep 2-iv) makes it possible to evaporate part of the liquid (water or organic solvent) from the aqueous or organic solution, to obtain the aqueous or organic paste with a suitable viscosity for carrying out step 3).

In the present invention, the solvent of the “aqueous solution” or of the “aqueous suspension” comprises at least about 80 vol % of water, and preferably at least about 90 vol % of water, relative to the total volume of the solution.

In the present invention, the solvent of the “organic solution” or of the “organic suspension” comprises at least about 80 vol % of organic solvent, and preferably at least about 90 vol % of organic solvent, relative to the total volume of the solution.

The organic solvent may be selected from cyclohexane and toluene.

The solvent of the aqueous solution (or of the aqueous suspension) is advantageously only water, distilled water or ultrapure distilled water.

According to a preferred embodiment of the invention, the solution and the suspension from substeps 2-i) and 2-ii) are aqueous and step 2) thus makes it possible to prepare an aqueous paste.

Step 3)

The current collector CC may be selected from a metallic material, a carbon-containing material, a silicon-based material, a textile material, a metallic material modified by a layer of carbon, transition metal nitride or conductive polymer (e.g. polyaniline, polypyrrole, polythiophene) and a material consisting of a layer of composite polymer and a layer of carbon-containing material.

As examples of metallic material, we may mention stainless steel, aluminium, iron, copper, gold, nickel or one of the alloys of the aforementioned metals.

As examples of carbon-containing material, we may mention vitreous carbon, graphite or carbon fibres, notably in the form of a fabric of the unidirectional type, a cloth, a taffeta, a cotton serge, paper or satin.

As examples of silicon-based material, we may mention polycrystalline, single-crystal or amorphous silicon, glass or glass fibres, notably in the form of a fabric of the unidirectional type, a cloth, a taffeta, a cotton serge, paper or satin.

As examples of textile material, we may mention any type of fabric of the unidirectional type, cloth, taffeta, cotton serge, paper or satin.

The current collector may be porous (e.g. grating, fibres or several intermingled gratings) or non-porous.

The CC may be flexible (i.e. pliable) or rigid.

It may be in the form of a plate, a sheet, a fabric of the unidirectional type, a cloth, a taffeta, a cotton serge, paper or satin.

The choice of the material used for the CC will depend on the application envisaged.

To obtain a flexible composite electrode, a carbon-containing material such as carbon fibres, notably in the form of a fabric, is preferred as CC.

To improve the mechanical durability of the composite electrode while guaranteeing good flexibility, a material consisting of a layer of polymer composite and a layer of carbon-containing material may be used as CC. In this case, the composite electrode material will of course be applied on the layer of carbon-containing material.

The polymer composite may comprise an insulating polymer and a metal (e.g. metal powder).

The insulating polymer may be selected from polyurethane, unsaturated polyester and an epoxy resin.

The metal may be selected from nickel, gold, aluminium and platinum.

The carbon-containing material may be as defined above, and preferably carbon fibres, notably in the form of a fabric.

According to an especially preferred embodiment of the invention, the CC is functionalized.

In this case, the method then further comprises an additional step prior to step 3), in which the CC is functionalized to form a functionalized current collector CC-f.

When the CC is functionalized to form a functionalized current collector CC-f, said crosslinked hydrophilic polymer PH-r of the composite material is also bound covalently to the CC-f via said ester functions selected from esters of carboxylic acids, esters of phosphonic acids, esters of sulphonic acids and carbamates.

When the current collector is a carbon-containing material or a metallic material modified by a layer of carbon or a material consisting of a layer of polymer composite and a layer of carbon-containing material, the methods of functionalization as described in the invention may also be used to give the functionalized carbon-containing agent CE-f.

In particular, the CC (carbon-containing surface or carbon-containing part of the CC) may be functionalized using a reagent T′-X′-L′, in which:
the group T′ is a functional group capable of reacting with CC to form a covalent bond or a precursor functional group of a functional group capable of reacting with CC to form a covalent bond;
the group X′ is a conjugated spacer group, i.e. a group that comprises a system of atoms bound by a covalent bond to at least one delocalized π bond;
the group L′ is selected from the following functional groups: carboxylic acid [—CO₂M], acyl halide [—COX], acid anhydride [—C(═O)OC(═O)—], sulphonic acid [—SO₂(OM)], sulphonic acid halide [—SO₂X], phosphonic acid dihalide [—POX₂], monoester halide of phosphonic acid [—POX(OR)], monoester of phosphonic acid [—PO(OR)(OM)], diester of phosphonic acid [—PO(OR)₂] or isocyanate [—N═C═O], with X, M and R being as defined in the invention.

The conjugated spacer group X′ may be an aryl group, i.e. an aromatic or heteroaromatic group, mono- or polycyclic, optionally substituted, having from 5 to 20 carbon atoms, notably from 5 to 14 carbon atoms, in particular from 6 to 8 carbon atoms. The heteroatom or heteroatoms that may be present in the aryl group is (are) advantageously selected from the group consisting of N, O, P or S.

In the case of an aromatic or heteroaromatic polycyclic group, each ring may comprise from 3 to 8 carbon atoms.

The spacer group X′ may also be a divalent group selected from the phenylene, oligophenylene, oligophenylenevinylene, oligophenyleneethynylene, oligothiophene and azobenzene groups.

The group T′ of a reagent T′-X′-L′ depends on the chemical nature of the CC that is to be modified.

The reagent T′-X′-L′ may be a diazonium salt or a precursor of a diazonium salt.

In the case when the reagent T′-X′-L′ is a diazonium salt, T′ is a diazonium cation. The counter-ion may be for example a BF₄⁻ or Cl⁻ anion.

Reaction of the current collector CC with a reagent T′-X′-L′ in which T′ is a diazonium cation is preferably performed chemically, notably in solution in acetonitrile or in water at pH 2, said solution containing from about 2 to 50 mM of diazonium salt.

In particular, a reagent T′-X′-L′ in which T′ is a diazonium cation may be produced in situ starting from a precursor NH₂—X′-L′ by adding a nitrosation agent such as tert-butyl nitrite [(CH₃)₃CONO or tBu-NO₂] in an organic medium (e.g. acetonitrile) or sodium nitrite (NaNO₂) in an acid medium (e.g. a medium with pH 1).

Generally, the molar ratio of nitrosation agent to NH₂—X′-L′ precursor is from about 1 to 5 and the molar ratio of NH₂—X′-L′ precursor to CC is from about 0.005 to 1.

Next, formation of the radical —X-L′ derived from the diazonium salt T′-X′-L′ may be induced in several ways: spontaneously, by UV or microwave radiation, by ultrasound, by thermal treatment or by electrochemistry.

Reaction of the current collector CC with a reagent T′-X′-L′ in which T′ is a diazonium cation may also be performed electrochemically in a three-electrode cell, at a potential below 0 V vs SCE (KCl-saturated calomel electrode), in which the electrolyte is a deaerated 0.1 M solution of NEt₄BF₄ or NBu₄BF₄ in acetonitrile, said solution containing from about 0.1 to 50 mM of diazonium salt.

When the CC is of stainless steel or aluminium, the electrochemical route is indispensable.

T′-X′-L′ is preferably such that L′ is —CO₂H or —CO₂M and T′ is —NH₂ (precursor functional group of the diazonium cation N₂⁺).

In particular, the reagent T′-X′-L′ may correspond to one of the following formulae:

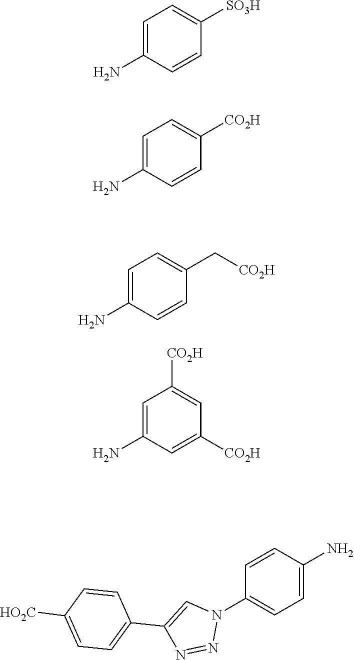

The reagents T-X-L and T′-X′-L′, allowing functionalization of CE and CC respectively, may be identical or different.

In step 3), thermal treatment of the aqueous or organic paste and of the optionally functionalized current collector CC is preferably carried out at a temperature of at least about 100° C.

According to a first variant, step 3) comprises:

3-i) a substep in which the optionally functionalized CC is placed in a container, such as a Teflon mould,

3-ii) a substep in which the aqueous or organic paste obtained in step 2) is poured into the container comprising the optionally functionalized CC, and

3-iii) a substep of thermal treatment of the container comprising the optionally functionalized CC and the aqueous or organic paste at a temperature of at least about 100° C., notably in a stove.

According to a second variant, step 3) comprises:

3-a) a substep in which the aqueous or organic paste is poured into a container such as a Teflon mould,

3-b) a substep of thermal treatment of the container comprising the aqueous or organic paste at a temperature of at least about 100° C., notably in a stove,

3-c) a substep in which the optionally functionalized CC is placed in the container, on top of the thermally treated aqueous or organic paste, and

3-d) a substep of maintaining the thermal treatment of the container comprising the optionally functionalized CC and the aqueous or organic paste at a temperature of at least about 100° C., notably in a stove.

The thermal treatment according to the two variants of step 3) allows formation of covalent bonds between the functional groups L of CE-f and the alcohol functions of the hydrophilic polymer PH and optionally between the functional groups L′ of the CC-f and the alcohol functions of the hydrophilic polymer PH, and thus lead to the formation of a fully crosslinked carbon-polymer hybrid matrix.

The crosslinking in step 3) may be accelerated by adding, to the aqueous or organic paste in step 2), coupling agents that are familiar to a person skilled in the art, such as 1,3-dicyclohexylcarbodiimide (DCC), N-hydroxybenzotriazole (HOBt), hexafluorophosphate of benzotriazol-1-yl-oxy-tris-(dimethylamino)phosphonium (BOP), tetrafluoroborate of 2-(1H-benzotriazol-1-yl)-1,1,3,3-teramethyluronium (TBTU), 2-(1H-azabenzotriazol-1-yl)-1,1,3,3-tetramethyluronium (HAUT), etc.

The composite electrode obtained at the end of step 3) displays improved mechanical durability and sufficient rigidity to hold the particles of MA in said composite electrode. In fact, chemical reaction between CE-f and PH makes it possible to form a crosslinked carbon-polymer matrix, trapping the particles of MA in situ.

Furthermore, the use of a hydrophilic polymer PH for the formulation of composite electrodes favours the mechanism of charge storage in an aqueous electrolytic medium, and allows better anchoring of the various conductive elements of the composite electrode (CE and CC) by a method of grafting on functionalized conductive surfaces.

Finally, chemical reaction between the CC when it is functionalized and PH makes it possible to ensure robust holding of the crosslinked carbon-polymer matrix on the CC, trapping the MA through the formation of multiple additional covalent bonds.

In a particular embodiment of the method of the invention, the ester functions are carboxylic acid ester functions.

The method of the invention preferably does not comprise step(s) of functionalization of the active material MA. The active material MA is therefore used “as is”, without chemical modification and/or introduction of chemical groups on its surface. In this way the ion and electron exchanges in the electrochemical storage device are optimized.

A second object of the invention is a composite electrode comprising a composite material deposited on an optionally functionalized current collector CC, as obtained by the method according to the first object of the invention, characterized in that:
said optionally functionalized current collector CC has a surface resistance less than or equal to about 50 ohms per 1 cm² of surface area (i.e. less than or equal to 50 ohms/cm²), and
said composite material comprises a functionalized carbon-containing agent CE-f, at least one active material MA, and at least one crosslinked hydrophilic polymer PH-r comprising several alcohol functions and several ester functions selected from esters of carboxylic acids, esters of phosphonic acids, esters of sulphonic acids and carbamates, said crosslinked hydrophilic polymer PH-r being bound covalently to the functionalized carbon-containing agent CE-f via said ester functions.

The carbon-containing agent CE-f, active material MA and the current collector CC are as defined in the first object of the invention.

When the CC is functionalized, said crosslinked hydrophilic polymer PH-r of the composite material is also bound covalently to the CC-f via said ester functions selected from esters of carboxylic acids, esters of phosphonic acids, esters of sulphonic acids and carbamates.

In a particular embodiment, the ester functions are carboxylic acid ester functions.

The composite material preferably comprises from about 30 to 90 wt % of MA, from about 5 to 70 wt % of CE-f, and from about 5 to 50 wt % of crosslinked hydrophilic polymer PH-r.

According to an especially preferred embodiment of the invention, the composite material comprises from about 30 to 80 wt % of MA, from about 5 to 40 wt % of CE-f, and from about 10 to 45 wt % of crosslinked hydrophilic polymer PH-r.

A third object of the invention is an electrochemical storage system comprising a positive electrode and a negative electrode separated by an electrolyte, characterized in that at least one of the electrodes is a composite electrode such as obtained by the method according to the first object of the invention or according to the second object of the invention.

Said electrochemical storage system may be a fuel cell, an electric battery (e.g. lithium or lithium-ion battery), a capacitor, a supercapacitor, an electrochromic window or a solar cell, and preferably a supercapacitor.

The electrolyte may be a solution of a sodium or lithium salt in a solvent.

The sodium salt is preferably selected from NaClO₄, NaBF₄, NaPF₆, Na₂SO₄, NaNO₃, Na₃PO₄, Na₂CO₃ and NaTFSI.

The lithium salt is preferably selected from LiClO₄, LiBF₄, LiPF₆, Li₂SO₄, LiNO₃, Li₃PO₄, Li₂CO₃ and LiTFSI.

The solvent may be water.

The solvent may also be a liquid organic solvent, optionally gelled with a polar polymer, or a polar polymer optionally plasticized by a liquid organic solvent.

The liquid organic solvent is preferably selected for example from linear ethers and cyclic ethers, esters, nitriles, nitrated derivatives, amides, sulphones, sulpholanes, alkylsulphamides and partially hydrogenated hydrocarbons. The particularly preferred solvents are diethyl ether, dimethoxyethane, glyme, tetrahydrofuran, dioxane, dimethyltetrahydrofuran, methyl or ethyl formate, carbonate of propylene, of ethylene, of vinylene or of fluoroethylene, alkyl carbonates (notably dimethyl carbonate, diethyl carbonate and methylpropyl carbonate), butyrolactones, acetonitrile, benzonitrile, nitromethane, nitrobenzene, dimethylformamide, diethylformamide, N-methylpyrrolidone, dimethylsulphone, tetramethylene sulphone, tetramethylene sulphone and the tetraalkylsulphonamides having from 5 to 10 carbon atoms.

The polar polymer may be selected from the solvating polymers, crosslinked or not, bearing or not bearing grafted ionic groups. A solvating polymer is a polymer that comprises solvating units containing at least one heteroatom selected from sulphur, oxygen, nitrogen and fluorine. As examples of solvating polymers, we may mention the polyethers of linear, comb or block structure, whether or not forming a network, based on poly(ethylene oxide), or the copolymers containing the ethylene oxide or propylene oxide unit or allylglycidyl ether, polyphosphazenes, crosslinked networks based on polyethylene glycol crosslinked by isocyanates or networks obtained by polycondensation and bearing groups that allow incorporation of crosslinkable groups. We may also mention the block copolymers in which certain blocks bear functions that have redox properties. Of course, the list above is not limiting, and all polymers having solvating properties may be used.

A fourth object of the invention is the use of the composite electrode as obtained by the method according to the first object of the invention or according to the second object of the invention in an energy storage system (e.g. in a flexible or rigid supercapacitor or a battery, and preferably in a supercapacitor), in a sensor, or a detector of gases, ions or pollutants.

### EXAMPLES

The raw materials used in the examples are listed below:
nitrosation agent tBuNO₂, of 90% purity, Sigma-Aldrich,
nitrosation agent NaNO₂, of ≥97% purity, Sigma-Aldrich,
4-aminobenzoic acid, of 99% purity, Alfa Aesar,
carbon nanofibres, of >98% purity, vapour grown nanofibre VGCF, Sigma-Aldrich, 100 nm×20-200 μm,
carbon black, of ≥99% purity, Superior Graphite,
acetonitrile, of >99.8% purity, Fisher Scientific,
N,N-dimethylformamide, of >99% purity, Acros Organics,
methanol, of >99.5% purity, Fisher Scientific,
distilled water,
acetone, of >99% purity, Fisher Scientific,
anhydrous Na₂SO₄, of ≥99% purity, Fisher Scientific,
carbon fabric, Granoc Fabric PF-YSH70A-100, Nippon Graphite Fiber Corporation,
MnO₂, High Specific Surface Area, cryptomelane, Erachem Comilog, particle size from 2 to 5 μm,
Fe₃O₄, of 95% purity, Sigma-Aldrich, particle size <5 μm,
Fe₃O₄, of 97% purity, Sigma-Aldrich, particle size <5 μm,
“homemade” Fe₃O₄, particles of nanometric size <50 nm,
fumaric acid, ≥99% purity, Sigma-Aldrich,
polyacrylic acid (PAA), of >85% purity, Poly(acrylic acid sodium salt), Sigma-Aldrich, M_{w}˜2100 g·mol⁻¹,
polyvinyl alcohol, PVA, 98% hydrolysed, Sigma-Aldrich, M_{w}=13000-23000 g·mol⁻¹,
polyaniline, PANI, (emeraldine base), Sigma-Aldrich, M_{w}=5000 g·mol⁻¹,
polypyrrole, PPY, doped, 5 wt % dispersion in H₂O, Sigma Aldrich,
polyurethane resin for CC, mixture of Dilpur 40-80 Isocyanate+Dilpur 40A Polyol, DIL France, Hardness 40 Shore A,
isocyanate for CC, Dilpur 40-80 Isocyanate, DIL France, density of 1.05, viscosity of 5500 mPa·s,
polyol for CC, Dilpur 40A Polyol, DIL France, density of 1.04, viscosity of 350 mPa·s,
nickel powder for CC, purity 99.9%, Alfa Aesar, particles of size 3-7 μm.

Unless stated otherwise, all the materials were used as received.

### Example 1: Method for Preparing a Composite Electrode E-1 According to the First Object of the Invention

1.1 Preparation of a Functionalized Carbon-Containing Agent CE¹-f (e.g. Functionalized Carbon Nanofibres)

A solution A was prepared comprising 3.08 g of tert-butyl nitrite as nitrosation agent in 50 ml of acetonitrile.

A solution B was prepared comprising 1.37 g of 4-aminobenzoic acid (0.05 mol/l) and 400 mg of carbon nanofibres (i.e. 3.33×10⁻² mol of carbon) in 200 ml of acetonitrile.

Solution A was added dropwise to solution B to form a resultant solution that was stirred for 16 h, and then filtered.

In the resultant solution, the molar ratio of nitrosation agent to 4-aminobenzoic acid was 3 and the molar ratio of 4-aminobenzoic acid to carbon of the carbon fibres was 0.3.

The precipitate obtained was washed several times with 200 ml portions of various solvents: the first washing operations were performed in an aqueous medium with water (×5) and then with various organic solvents such as acetonitrile (×5 or until the filtrate is colourless), dimethylformamide (×5 or until the filtrate is colourless), acetone (×3) and methanol (×3).

The solid obtained was then dried under vacuum for 24 h.

Carbon nanofibres functionalized with benzoic acid (CE¹-f) were prepared in this way.

1.2 Preparation of a Functionalized Carbon Fabric CC¹-f

A solution A was prepared comprising 0.616 g of tert-butyl nitrite as nitrosation agent in 50 ml of acetonitrile.

A solution B was prepared comprising 0.274 g of 4-aminobenzoic acid (0.01 mol/l) and two pieces of carbon fabric with dimensions of 10 cm×5 cm (i.e. 0.205 mol of carbon) in 200 ml of acetonitrile. The two pieces of carbon fabric were thus immersed in said solution B and kept in suspension by means of two clamps located above a container with said solution B.

Solution A was added dropwise to solution B to form a resultant solution, which was stirred for 16 h, and then filtered.

In the resultant solution, the molar ratio of nitrosation agent to 4-aminobenzoic acid was 3 and the molar ratio of 4-aminobenzoic acid to carbon of the carbon fibres was 0.01.

The fabric obtained was washed and then treated ultrasonically for 3 to 5 min in different solvents: acetonitrile (×3), methanol and acetone.

The fabric was then dried under vacuum for 24 h.

A carbon fabric functionalized with benzoic acid (CC¹-f) was prepared in this way and can be used as a current collector.

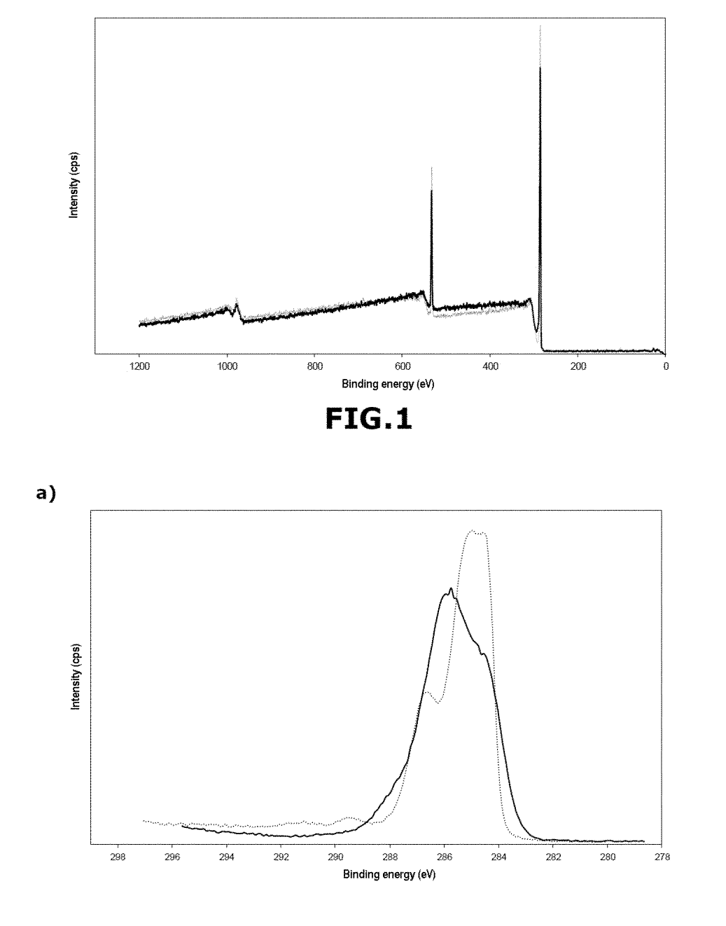

FIG. 1 (broad spectrum) shows analysis by X-ray photoemission spectroscopy (XPS analysis) of the non-functionalized carbon fabric (curve with solid lines) and the functionalized carbon fabric (curve with dotted lines).

The curves represent the intensity (in number of photoelectrons) as a function of their binding energy (in eV). This analysis makes it possible to identify the chemical elements present on the surface of the carbon fabric.

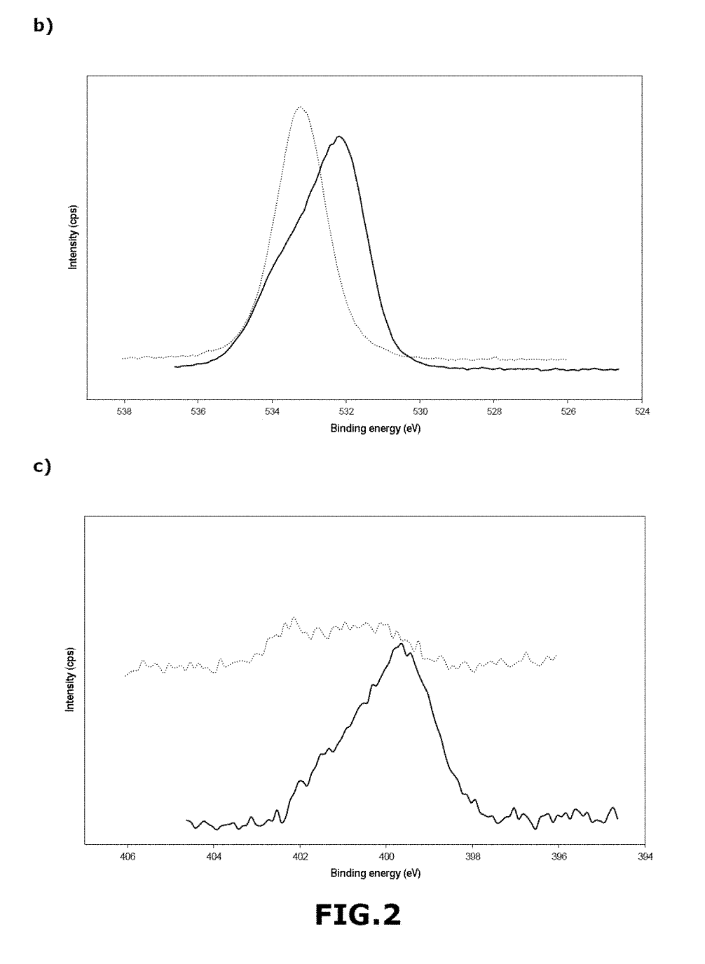

FIG. 2 (zone spectra) in X-ray photoemission spectroscopy (XPS) of the non-functionalized carbon fabric (solid line) and functionalized carbon fabric (dotted line).

In particular, the enlarged FIGS. 2a, 2b and 2c of FIG. 2 show the spectra of the C1s, O1s and N1s peaks, respectively. They show that the surface of the functionalized carbon fabric is chemically modified. In particular, FIG. 2a shows a decrease of the peak Cis at 284 eV relating to the C—C bond (sp² carbons at 284.3 eV and spa at 284.8 eV) and the presence of the C—O—C bonds at 285.8 eV and O—C═O bonds at 288 eV on the surface of the functionalized carbon fabric, said groups being visible in FIG. 2b of the O1s peak at about 232 eV and 234 eV.

1.3 Preparation of the Composite Electrode E-1

A solution C comprising 10 wt % of PVA was prepared by dissolving PVA in water at 80° C.

A solution D was prepared by dispersing 100 mg of MnO₂ in 10 ml of water using ultrasound for 30 min, and then adding and dispersing 20 mg of modified carbon nanofibres as prepared in example 1.1 with the aid of ultrasound for 30 min.

800 mg of solution C was then added gradually, with stirring, to solution D.

The resultant solution was stirred for at least 24 h at 80° C., so as to evaporate some of the water and obtain a paste of composite material having a suitable texture for spreading uniformly on the modified carbon fabric as prepared in example 1.2.

The composition by weight of the composite material thus prepared for the electrode E-1 was 50% of MnO₂, 40% of PVA and 10% of functionalized carbon nanofibres CE¹-f.

The modified carbon fabric CC¹-f as prepared in example 1.2 was placed at the bottom of a dismountable Teflon mould (with dimensions of 10 cm×10 cm) specially designed for easy recovery of the fabric, and the paste of composite material was poured onto said fabric in order to promote the esterification reaction on the surface of the fabric.

The mould containing the fabric and the composite material paste was maintained at 120° C. in a stove in order to remove all traces of water and shift the equilibrium of the esterification reaction towards the formation of the ester and full crosslinking of the carbon-polymer hybrid matrix.

The current collector CC¹-f coated with the paste of composite material was then recovered by detaching it from the walls of the mould using a scalpel.

It could then be used directly as composite electrode E-1 simply by establishing an electrical contact at one of its ends, while the other end was immersed in a liquid electrolyte.

1.4 Characteristics of the Composite Electrode E-1

The electrode E-1 was tested electrochemically by cyclic voltammetry on about ten cycles at room temperature in a three-electrode cell comprising:
the electrode E-1 as the working electrode, said electrode having a surface area of 1 cm²,
an aqueous liquid electrolyte consisting of 0.5M aqueous solution of Na₂SO₄,
an Ag/AgCl (saturated NaCl) electrode as reference electrode, and
a platinum electrode as counter electrode.

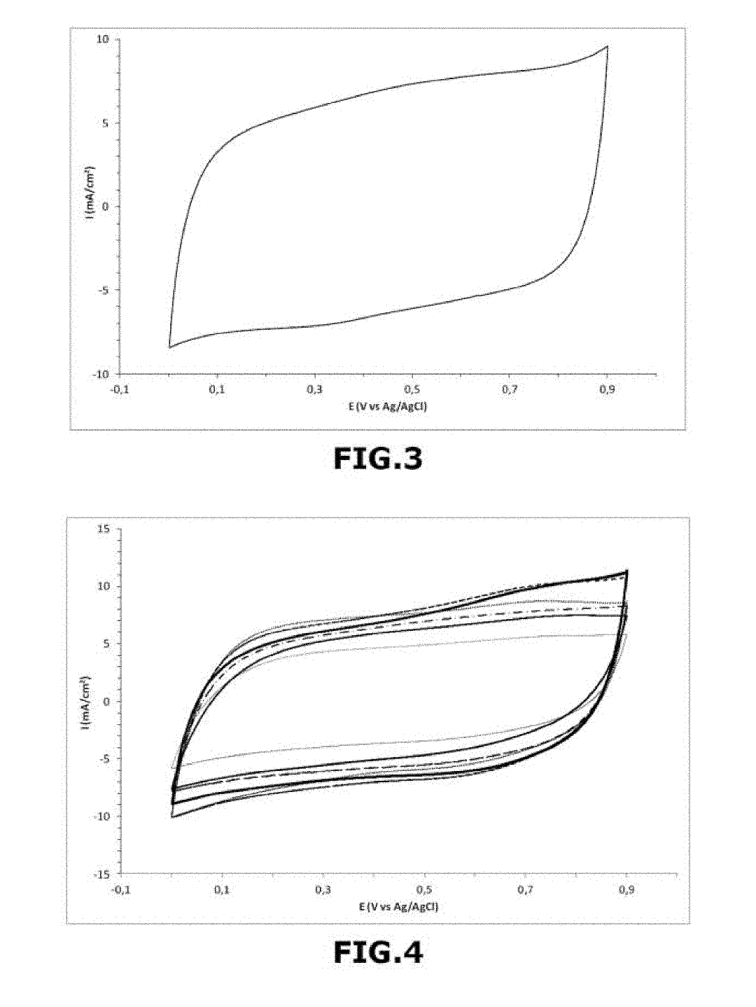

Measurement of current density I (in mA/cm²) as a function of the potential applied (i.e. from 0.0 V to 0.9 V) versus the Ag/AgCl reference electrode is presented in FIG. 3, using a cycling rate of 20 mV/s after 10 cycles.

The carbon-polymer hybrid matrix trapping the active material, together with the use of a functionalized current collector, makes it possible to obtain an electrode E-1 displaying good electrochemical performance as the positive electrode in a supercapacitor.

In fact, the electrode E-1 has a surface capacitance of 0.3 F/cm² and a specific capacitance of 147 F/g.

The electrode E-1 was tested in galvanostatic cycling on 3000 cycles between 0.0 V and 0.9 V, at a constant current density of 7 mA·cm⁻², at room temperature, in a three-electrode cell comprising:
the electrode E-1 as the working electrode, said electrode having a surface area of 1 cm²,
an aqueous liquid electrolyte consisting of 0.5 M aqueous solution of Na₂SO₄,
an Ag/AgCl (saturated NaCl) electrode as reference electrode, and
a platinum electrode as counter electrode.

During the galvanostatic cycling, the electrode E-1 was additionally tested by cyclic voltammetry in different charge-discharge cycles.

After 1000 and 2000 cycles, the electrode E-1 and the mounting were washed, dried, and then cycling was begun again with fresh electrolyte.

Measurement of the current density I (in mA/cm²) as a function of the potential applied (i.e. between 0.0 V and 0.9 V) versus the Ag/AgCl reference electrode is presented in FIG. 4, using a cycling rate of 20 mV/s, after the following different cycles of galvanostatic cycling: before cycling (curve with a solid line), after 100 cycles (curve with a thick dotted line), after 500 cycles (curve with a thin dotted line), after 1000 cycles (curve with an alternating dotted line), after 2000 cycles (curve with a thin solid line) and after 3000 cycles (curve with a very thin dotted line).

Functionalization of the current collector gave durable adherence of the carbon-polymer matrix trapping the active material on the functionalized current collector, for 3000 cycles.

### Example 2: Method for Preparing Composite Electrodes E-2 and E-3 According to the First Object of the Invention

A composite electrode E-2 was prepared by the method described in example 1.3, using 200 mg of active material MnO₂ in place of 100 mg of MnO₂ and using an unmodified current collector CC¹ (i.e. carbon fabric with dimensions of 10 cm×5 cm that has not undergone functionalization).

The composition by weight of the composite material thus prepared for the composite electrode E-2 was 67% of MnO₂, 27% of PVA and 6% of functionalized carbon nanofibres CE¹-f.

A composite electrode E-3 was then prepared by the method described in example 1.3, using 200 mg of active material MnO₂ in place of 100 mg of MnO₂ and using a modified current collector CC¹-f as prepared in example 1.2.

The composition by weight of the composite material thus prepared for the composite electrode E-3 was 67% of MnO₂, 27% of PVA and 6% of functionalized carbon nanofibres CE¹-f.

The electrodes E-2 and E-3 were tested electrochemically by cyclic voltammetry on about ten cycles, at room temperature, in a three-electrode cell comprising:
the electrode E-2 or E-3 as the working electrode, each of the electrodes having a surface area of 1 cm²,
an aqueous liquid electrolyte consisting of 0.5 M aqueous solution of Na₂SO₄,
an Ag/AgCl (saturated NaCl) electrode as reference electrode, and
a platinum electrode, as counter electrode.

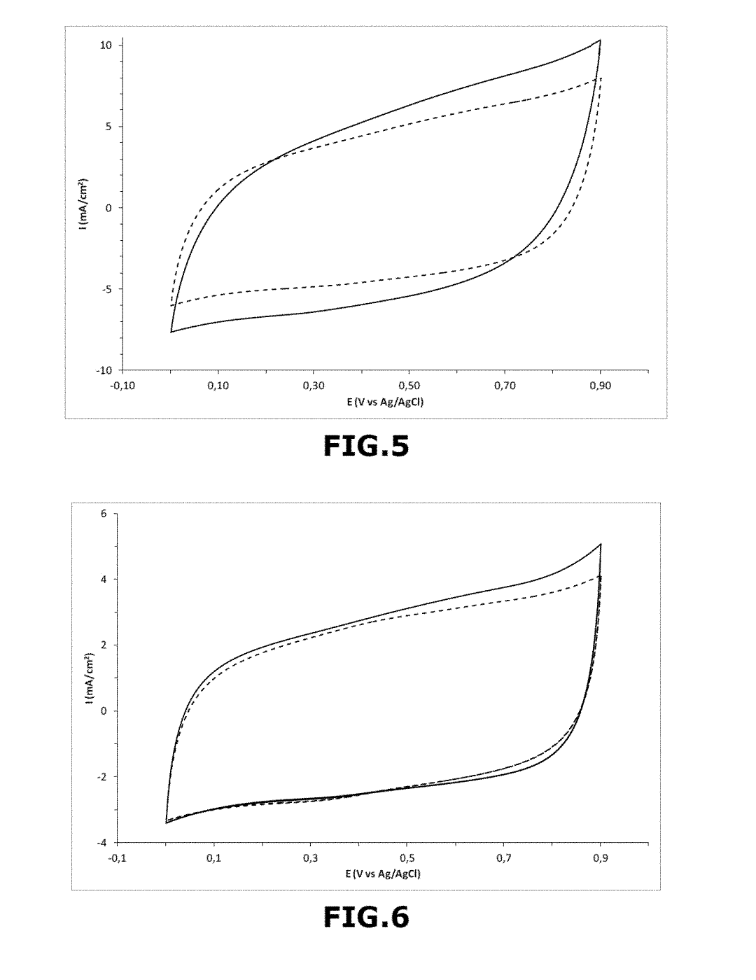

Measurement of the current density I (in mA/cm²) of the electrodes E-2 (solid line) and E-3 (dotted line) as a function of the potential applied (i.e. from 0.0 V to 0.9 V), versus the Ag/AgCl reference electrode, is presented in FIG. 5 using a cycling rate of 20 mV/s after 10 cycles.

Surface modification of the carbon fabric leads to a slight decrease in current density, but makes it possible to obtain a pseudocapacitance signal that is more rectangular and less resistive, due to more durable adherence of the paste on the current collector.

### Example 3: Method for Preparing Composite Electrodes E-4 and E-5 According to the First Object of the Invention

3.1 Preparation of a Material Consisting of a Layer of Polymer Composite and a Layer of Carbon-Containing Material CC²

A polyurethane resin filled with 80 wt % of nickel, PU—Ni, was prepared as follows:

4 g of isocyanate and 4 g of polyol were mixed to obtain a homogeneous viscous liquid. 32 g of nickel powder was added gradually (successive additions of 16 g, 8 g and 8 g) and mixed with the viscous liquid. Some drops of acetone (about fifty) were added to liquefy and thoroughly homogenize the mixture.

The resultant mixture was spread using a spatula on a previously polished 15×23 cm² Teflon plate (or glass plate) and was left to crosslink for 2 to 3 h at room temperature, until a sticky surface of polyurethane resin-nickel (PU—Ni) with a thickness of about 500 μm was obtained.

A carbon fabric (not functionalized) was then applied on the PU—Ni resin. The whole was left for about 24 h at room temperature until the resin was fully crosslinked and it was then recovered by detaching it from the Teflon plate using a scalpel.

A material consisting of a layer of filled resin PU—Ni and a layer of non-functionalized carbon fabric was thus obtained and may be used as a current collector CC² useful for development of a composite electrode according to the invention.

The method may also be reproduced using a functionalized carbon fabric such as that prepared in example 1.2. A functionalized current collector CC²-f is thus obtained, consisting of a layer of filled resin PU—Ni and a layer of functionalized carbon fabric.

The PU—Ni filled resin is flexible, conductive and it coats the back of the optionally functionalized carbon fabric and makes it possible to improve its mechanical durability and make it easier to handle.

The filled resin is sufficiently conductive to allow the whole (optionally functionalized carbon fabric/filled resin) to be used as the current collector of an electrode for energy storage devices. The current collector thus obtained consists of a layer of composite polymer (PU—Ni) and a layer of carbon-containing material (optionally functionalized carbon fabric).

3.2 Preparation of the Composite Electrodes E-4 and E-5

A composite electrode E-4 was prepared by the method described in example 1.3, using an unmodified current collector CC¹ (i.e. carbon fabric with dimensions of 10 cm×5 cm that has not undergone functionalization).

The composition by weight of the composite material thus prepared for the composite electrode E-4 was 50% of MnO₂, 40% of PVA and 10% of functionalized carbon nanofibres CE¹-f.

A composite electrode E-5 was prepared by the method described in example 1.3, using an unmodified current collector CC² as prepared in example 3.2 (i.e. carbon fabric with dimensions of 10 cm×5 cm that has not undergone functionalization, coated with a PU—Ni resin).

In the method for preparing the composite electrode E-5, the current collector CC² is placed at the bottom of the dismountable Teflon mould (as described in example 1.3), the face corresponding to the PU—Ni resin being in contact with the mould, whereas the face corresponding to the carbon fabric is able to receive the aqueous paste directly.

The composition by weight of the composite material thus prepared for the composite electrode E-5 was 50% of MnO₂, 40% of PVA and 10% of functionalized carbon nanofibres CE¹-f.

The electrodes E-4 and E-5 were tested electrochemically by cyclic voltammetry on about ten cycles, at room temperature, in a three-electrode cell comprising:
the electrode E-4 or E-5 as the working electrode, each of the electrodes having a surface area of 1 cm²,
an aqueous liquid electrolyte consisting of 0.5 M aqueous solution of Na₂SO₄,
an Ag/AgCl (saturated NaCl) electrode as reference electrode, and
a platinum electrode as counter electrode.

Measurement of the current density I (in mA/cm²) of the electrodes E-4 (solid line) and E-5 (dotted line) as a function of the potential applied (i.e. from 0.0 V to 0.9 V), versus the Ag/AgCl reference electrode, is presented in FIG. 6, using a cycling rate of 20 mV/s after 10 cycles.

The presence of the PU—Ni filled resin barely alters the electrochemical signal of the electrode and it makes it possible to improve the mechanical durability of the electrode over time, and its flexibility. Furthermore, manipulation of the carbon fabric is easier when said resin is used.

### Example 4: Method for Preparing Composite Electrodes E-6 and E-7 According to the First Object of the Invention and a Composite Electrode E-8 not According to the Invention

A composite electrode E-6 was prepared by the method described in example 1.3, using 100 mg of CE¹-f in place of 20 mg of CE¹-f and using an unmodified current collector CC² as prepared in example 3.1 (i.e. carbon fabric with dimensions of 10 cm×5 cm that has not undergone functionalization, coated with a PU—Ni resin).

The composition by weight of the composite material thus prepared for the composite electrode E-6 was 36% of MnO₂, 28% of PVA and 36% of functionalized carbon nanofibres CE¹-f.

A composite electrode E-7 was prepared by the method described in example 1.3, using 100 mg of CE¹-f in place of 20 mg of CE¹-f and using a modified current collector CC²-f as described in example 3.1 (i.e. carbon fabric with dimensions of 10 cm×5 cm that has undergone functionalization as in example 1.2 and has been coated with a PU—Ni resin).

The composition by weight of the composite material thus prepared for the composite electrode E-7 was 36% of MnO₂, 28% of PVA and 36% of functionalized carbon nanofibres CE¹-f.

A composite electrode E-8 (not forming part of the invention) was prepared by the method described in example 1.3, using 100 mg of CE¹-f in place of 20 mg of CE¹-f and using a current collector CC³ consisting only of the PU—Ni resin as prepared in example 3.1.

The current collector is not according to the invention as it does not have a surface resistance less than or equal to about 50 ohms/cm².

The composition by weight of the composite material thus prepared for the composite electrode E-8 was 36% of MnO₂, 28% of PVA and 36% of functionalized carbon nanofibres CE¹-f.

The electrodes E-6, E-7 and E-8 were tested electrochemically by cyclic voltammetry on about ten cycles, at room temperature, in a three-electrode cell comprising:
the electrode E-6, E-7 or E-8 as the working electrode, each of the electrodes having a surface area of 1 cm²,
an aqueous liquid electrolyte consisting of 0.5 M aqueous solution of Na₂SO₄,
an Ag/AgCl (saturated NaCl) electrode as reference electrode, and
a platinum electrode as counter electrode.

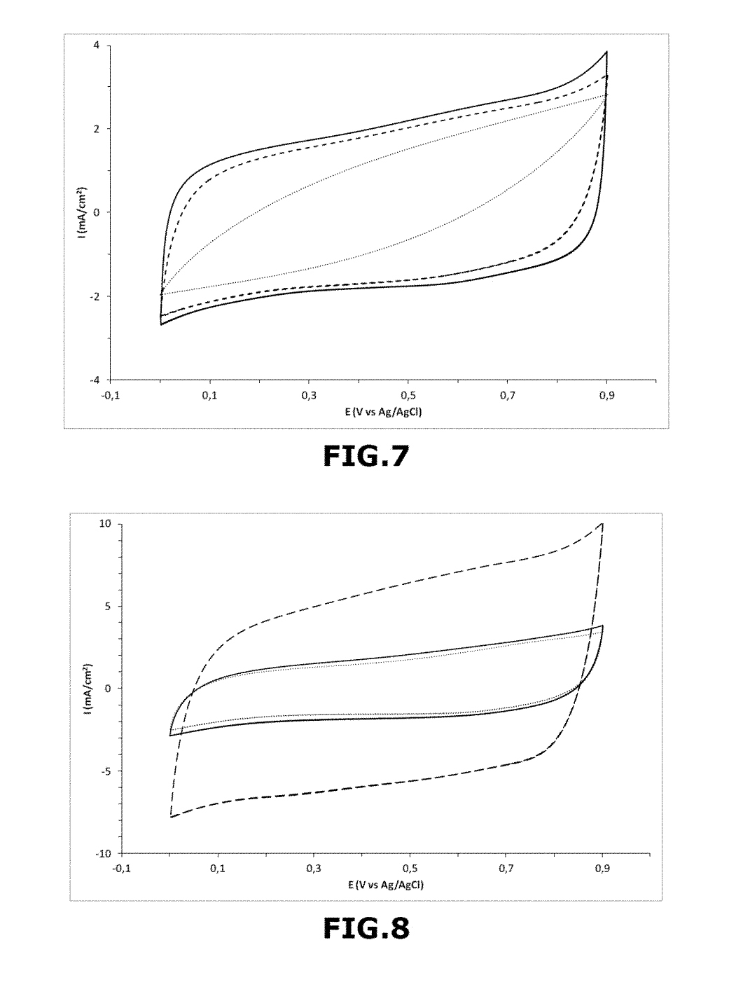

Measurement of the current density I (in mA/cm²) of the electrodes E-6 (solid line), E-7 (thick dotted line) and E-8 (thin dotted line) as a function of the potential applied (i.e. from 0.0 V to 0.9 V), versus the Ag/AgCl reference electrode, is presented in FIG. 7, using a cycling rate of 20 mV/s after 10 cycles.

The current density of the electrode E-8 without carbon fabric is much lower and the signal is much more resistive than for the electrodes E-6 and E-7, thus showing the pronounced influence of the conductive carbon fabric (functionalized or unfunctionalized) in the current collector. Surface modification of the carbon fabric (functionalization) is, moreover, favourable to good adherence of the paste on the current collector and only alters the electrochemical signal of the electrode very slightly.

### Example 5: Method for Preparing a Composite Electrode E-9 According to the First Object of the Invention

A solution C comprising 10 wt % of PVA was prepared by dissolving PVA in water at 80° C.

A solution D was prepared by dispersing 100 mg of MnO₂ in 10 ml of water using ultrasound for 30 min, and then adding and dispersing 100 mg of modified carbon nanofibres as prepared in example 1.1 with the aid of ultrasound for 30 min.

800 mg of solution C was then added gradually, with stirring, to solution D.

The resultant solution was stirred for at least 24 h at 80° C., and was then placed directly at the bottom of a dismountable Teflon mould (with dimensions of 10 cm×10 cm) as described in example 1.3. The mould containing the solution was maintained at 120° C. for 2 h to allow crosslinking of the PVA.

The composition by weight of the composite material thus prepared for electrode E-9 was 36% of MnO₂, 28% of PVA and 36% of functionalized carbon nanofibres CE¹-f.

The current collector CC² (i.e. carbon fabric with dimensions of 10 cm×5 cm that has not undergone functionalization, coated with a PU—Ni resin) as prepared in example 3.1 was deposited on the crosslinked paste, the face corresponding to the carbon fabric being in contact with said crosslinked paste. Some drops of water had been deposited beforehand on the crosslinked paste in order to allow better contact between crosslinked paste and carbon fabric, and promote the esterification reaction on the surface of the paste (i.e. in reverse order relative to the method as described in example 1.3).

The whole was once again held at 120° C. in a stove until all the water had evaporated and there was full crosslinking of the carbon-polymer hybrid matrix.

The paste of composite material covered with the current collector CC² was then recovered by detaching it from the walls of the mould using a scalpel.

The electrode E-9 was tested [and by comparison the electrodes E-6 and E-7 as prepared in example 4)] electrochemically by cyclic voltammetry on about ten cycles, at room temperature, in a three-electrode cell comprising:
the electrode E-6, E-7 or E-9 as the working electrode, each of the electrodes having a surface area of 1 cm²,
an aqueous liquid electrolyte consisting of 0.5 M aqueous solution of Na₂SO₄,
an Ag/AgCl (saturated NaCl) electrode as reference electrode, and
a platinum electrode as counter electrode.

Measurement of the current density I (in mA/cm²) of the electrodes E-6 (solid line), E-7 (thin dotted line) and E-9 (thick dotted line) as a function of the potential applied (i.e. from 0.0 V to 0.9 V), versus the Ag/AgCl reference electrode, is presented in FIG. 8, using a cycling rate of 20 mV/s after 10 cycles.

The electrode E-9 has a much higher density than the electrodes E-6 and E-7, whatever the value of the potential, indicating that the method of depositing the current collector on the aqueous paste [second variant of step 3) of the invention] leads to improved electrochemical performance.

Furthermore, as shown in example 4, functionalization of the carbon fabric in the collector barely alters the electrochemical signal of the electrode but guarantees improved adherence of the paste on the current collector.

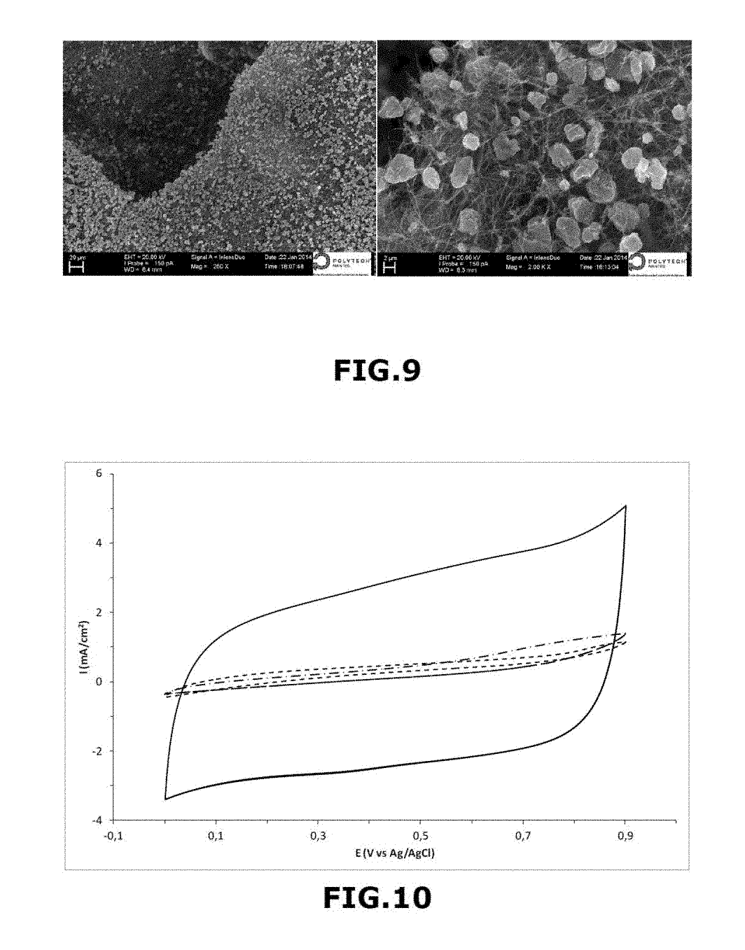

FIG. 9 shows scanning electron microscopy (SEM) images of the surface of the composite material of the composite electrode E-9 that is not in contact with the current collector.

FIG. 9 shows that the method employed in this example allows movement by gravity of the particles of active material MnO₂ at the bottom of the mould during crosslinking/gelation and thus access to a larger amount of MnO₂ on the free surface of the paste that will be in direct contact with the electrolyte of the electrochemical device.

The microscopy images were obtained using apparatus sold under the trade name Merlin by the company Zeiss.

### Comparative Example 6: Method for Preparing Composite Electrodes E-A and E-B not According to the First Object of the Invention

The method for preparing the electrode E-4 as described in example 3.2 was reproduced using, in place of the polyvinyl alcohol in the aqueous paste, other hydrophilic polymers not comprising alcohol functions. The functionalized carbon-containing agent CE¹-f was identical to that prepared in example 1.1. The active material was identical to that used in example 1.3 and the current collector was the unmodified current collector CC¹ (i.e. carbon fabric with dimensions of 10 cm×5 cm that has not undergone functionalization).

Table 1 below shows the concentrations by weight of each of the constituents of the composite material of the different electrodes prepared E-A and E-B and by comparison those of the electrode E-4 from example 3.2:

TABLE 1

| | | | wt % | Type of hydrophilic |
|---|---|---|---|---|
| | wt % | wt % | Hydrophilic | polymer |
| | CE¹-f | MA | polymer PH | PH |
| E-4 | 10 | 50 | 40 | Polyvinyl alcohol |
| | | | | PVA |
| E-A⁽*⁾ | 10 | 50 | 40 | Polyaniline |
| | | | | PANI |
| E-B⁽*⁾ | 10 | 50 | 40 | Polypyrrole |
| | | | | PPY |

⁽*⁾composite electrode not forming part of the invention

The two electrodes E-A and E-B not according to the invention (and by comparison the electrode E-4 as prepared in example 3.2) were tested electrochemically by cyclic voltammetry on about ten cycles, at room temperature, in a three-electrode cell comprising:
the electrode E-4, E-A or E-B as the working electrode, each of the electrodes having a surface area of 1 cm²,
an aqueous liquid electrolyte consisting of 0.5 M aqueous solution of Na₂SO₄,
an Ag/AgCl (saturated NaCl) electrode as reference electrode, and
a platinum electrode as counter electrode.

Measurements of the current density I (in mA/cm²) as a function of the potential applied (i.e. from 0.0 V to 0.9 V) versus the Ag/AgCl reference electrode for the electrode E-4 (solid line), the electrode E-A (thin dotted line) and the electrode E-B (alternating dotted line) are presented in FIG. 10, using a cycling rate of 20 mV/s after 10 cycles.

According to FIG. 10, the electrodes not forming part of the invention E-A and E-B have a low current density whatever the value of the potential, indicating that there is no creation of a carbon-polymer hybrid matrix trapping the active material like that of the invention.

Electrochemical testing by cyclic voltammetry of the composite material “alone” of the electrodes E-A and E-B (i.e. without current collector CC¹) or deposited on a current collector CC¹-f did not make it possible to improve the electrochemical signal such as observed in FIG. 9 for the electrodes E-A and E-B, whereas an electrochemical test by cyclic voltammetry of the composite material “alone” of the electrode E-4 (i.e. without current collector CC¹) gives an electrochemical signal, even if it is very resistive.

### Comparative Example 7: Method for Preparing Composite Electrodes E-C and E-D not According to the First Object of the Invention

The method for preparing the electrode E-4 as described in example 3.2 was reproduced using, in place of the functionalized carbon-containing agent CE¹-f (i.e. carbon nanofibres functionalized with benzoic acid) in the aqueous paste, an unfunctionalized carbon-containing agent CE² of carbon black NC (not according to the invention) as well as a bonding agent AL containing carboxylic acid functions (polyacrylic acid PAA or fumaric acid FAc). The active material and the hydrophilic polymer were identical to those used in example 1.3, and the current collector was the unmodified current collector CC¹ (i.e. carbon fabric with dimensions of 10 cm×5 cm that has not undergone functionalization).

Table 2 below shows the concentrations by weight of each of the constituents of the composite material of the different electrodes prepared E-C and E-D and by comparison those of the electrode E-4 of example 3.2:

TABLE 2

| | | | | Weight of AL | AL/ | Type of | |
|---|---|---|---|---|---|---|---|
| | wt | wt | wt | added (per | PH | carbon- | |
| | % | % | % | 200 mg of | molar | containing | Type |
| | CE | MA | PH | MA + PH + CE) | ratio | agent CE | of AL |
| E-4 | 10 | 50 | 40 | 0 | 0 | CE¹-f | — |
| E-C⁽*⁾ | 10 | 50 | 40 | 1.88 mg | 0.2 | CE² | PAA |
| E-D⁽*⁾ | 10 | 50 | 40 | 5.2 mg | 10 | CE² | FAc |

⁽*⁾composite electrode not forming part of the invention

The two electrodes E-C and E-D not according to the invention (and by comparison the electrode E-4 as prepared in example 3.2) were tested electrochemically by cyclic voltammetry on about ten cycles at room temperature in a three-electrode cell comprising:
the electrode E-4, E-C or E-D as the working electrode, each of the electrodes having a surface area of 1 cm²,
an aqueous liquid electrolyte consisting of 0.5 M aqueous solution of Na₂SO₄,
an Ag/AgCl (NaCl-saturated) electrode as reference electrode, and
a platinum electrode as counter electrode.

Measurements of the current density I (in mA/cm²) as a function of the potential applied (i.e. from 0.0 V to 0.9 V) versus the Ag/AgCl reference electrode for the electrode E-4 (solid line), the electrode E-C (thin dotted line) and the electrode E-D (alternating dotted line) are presented in FIG. 11, using a cycling rate of 20 mV/s after 10 cycles.

According to FIG. 11, the electrodes not forming part of the invention E-C and E-D have a low current density, whatever the value of the potential, indicating that there is little or no creation of a bonding agent AL-polymer hybrid matrix trapping the active material as well as the unfunctionalized carbon-containing agent CE². The bonding agent AL-polymer hybrid matrix potentially created seems even less present with fumaric acid FAc, a molecule of low molecular weight (116.07 g·mol⁻¹) than with the polyacrylic acid polymer PAA of high molecular weight (˜2100 g·mol⁻¹), as indicated by the electrochemical signal in FIG. 10.

### Example 8: Method for Preparing Composite Electrodes E-10, E-11, E-12 and E-13 According to the First Object of the Invention

The method for preparing the electrode E-1 as described in example 1.3 was reproduced using, in place of the active material MnO₂ in the aqueous paste, another active material Fe₃O₄, which may notably be used as the negative electrode of a supercapacitor.

The active material Fe₃O₄ was used in the form of three different powders: a commercial Fe₃O₄ powder (Sigma-Aldrich) for the electrode E-10, a commercial Fe₃O₄ powder (Alfa Aesar) for the electrode E-11 and an Fe₃O₄ powder prepared in the laboratory by the present inventors by the method as described in Kulkarni et al. [Ceramics International, 2014, 40 (1), part B, 1945-1949], for the electrode E-12.

The functionalized carbon-containing agent CE¹-f (i.e. functionalized carbon nanofibres) was identical to that as prepared in example 1.1 and the hydrophilic polymer (i.e. PVA) was identical to that used in example 1.3. The current collector was the current collector CC¹-f as prepared in example 1.2 (i.e. carbon fabric with dimensions of 10 cm×5 cm having undergone functionalization). The amount of active material Fe₃O₄ used for preparing the aqueous paste was identical in number of moles to the amount of MnO₂ used in the method of example 1.3 (i.e. 0.00115 mol), or 266 mg of Fe₃O₄.

The concentrations by weight of each of the constituents of the composite material of the electrodes E-10, E-11 and E-12 were 73% of Fe₃O₄ active material, 22% of hydrophilic polymer PVA and 5% of functionalized carbon nanofibres CE¹-f.

An electrode E-13 with the same composition as electrode E-12 (i.e. identical composite material and current collector) was prepared by the method as described in example 5 (i.e. by carrying out the second variant of step 3) of the method according to the invention).

The four electrodes E-10, E-11, E-12 and E-13 were tested electrochemically by cyclic voltammetry on about ten cycles at room temperature in a three-electrode cell comprising:
the electrode E-10, E-11, E-12 or E-13 as the working electrode, each of the electrodes having a surface area of 1 cm²,
an aqueous liquid electrolyte consisting of 0.5 M aqueous solution of Na₂SO₄,
an Ag/AgCl (saturated NaCl) electrode as reference electrode, and
a platinum electrode as counter electrode.

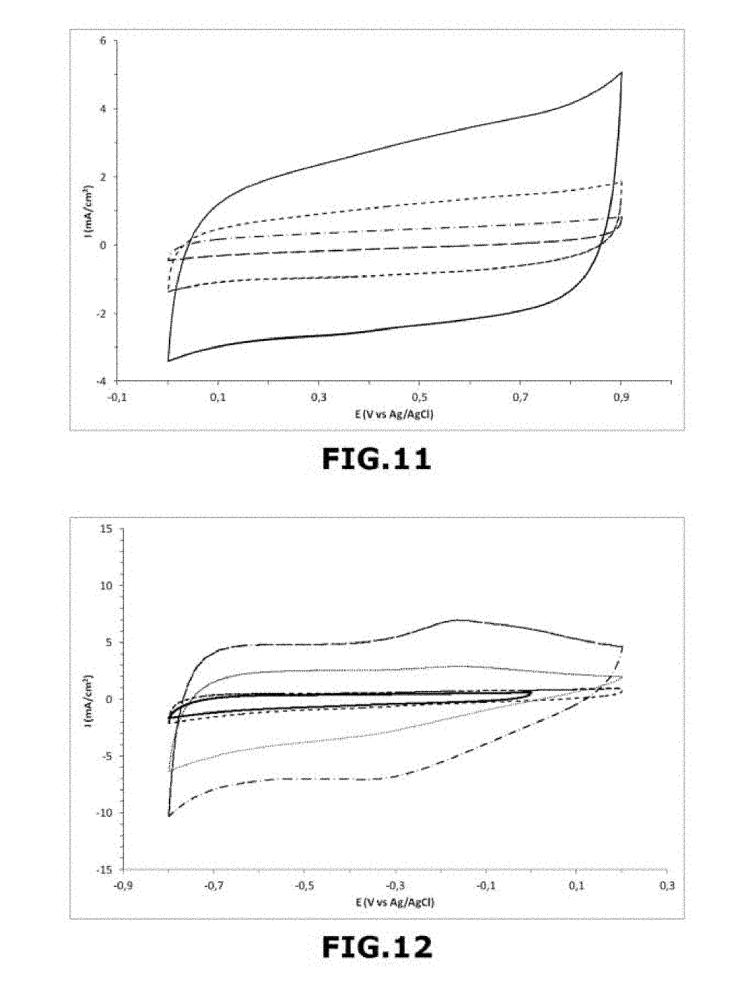

Measurements of the current density I (in mA/cm²) as a function of the potential applied (i.e. from −0.8 V to 0.2 V for E-11, E-12 and E-13 and from −0.8 V to 0.0 V for E-10) versus the Ag/AgCl reference electrode for the electrode E-10 (solid line), the electrode E-11 (thick dotted line), the electrode E-12 (thin dotted line) and the electrode E-13 (alternating dotted line) are presented in FIG. 12, using a cycling rate of 20 mV/s after 10 cycles from −0.8 V to 0.2 V (from −0.8 V to 0.0 V for E-12).

According to FIG. 12, the electrode E-13 has a higher current density than the other electrodes E-10, E-11 and E-12, confirming that the method of depositing the collector on the aqueous paste allows better contact of the active material with the electrolyte, leading to better electrochemical performance. Note that the electrodes E-12 and E-13 based on non-commercial Fe₃O₄ (i.e. prepared in the laboratory), with a nanometric particle size (i.e. size of about 10-20 nm), has a higher current density than the electrodes E-10 and E-11, based on commercial Fe₃O₄, with particle size below 5 μm.

### Example 9: Fabrication of an Asymmetric Supercapacitor According to the Fourth Object of the Invention Using Composite Electrodes According to the First Object of the Invention

A supercapacitor SC-1 was prepared according to an assembly with two asymmetric electrodes, by assembling:
the composite electrode E-9 as prepared in example 5, as positive electrode based on MnO₂,
a separator (Whatman® filter paper) impregnated with an aqueous liquid electrolyte consisting of 0.5 M aqueous solution of Na₂SO₄, and
the composite electrode E-13 as prepared in example 8, as negative electrode based on Fe₃O₄,

the assembly of electrodes and separator being held between two Teflon plates, screwed together at low pressure (i.e. slightly greater than simple contact, about 10⁵-10⁶ Pa), and

the assembly of electrodes and separator being immersed in said liquid electrolyte consisting of 0.5 M aqueous solution of Na₂SO₄.

The electrodes E-9 and E-13 were used directly, by establishing electrical contact at one of its ends with a crocodile clip, whereas 1 cm² of the other end was immersed in the liquid electrolyte, the clip and the electrode surplus being wrapped in Teflon tape, in order to insulate them from the electrolyte.

SC-1 was tested electrochemically, by chronopotentiometry at constant current, in galvanostatic cycling over 1000 cycles at room temperature.

During the galvanostatic cycling, SC-1 was additionally tested by cyclic voltammetry in different charge-discharge cycles.

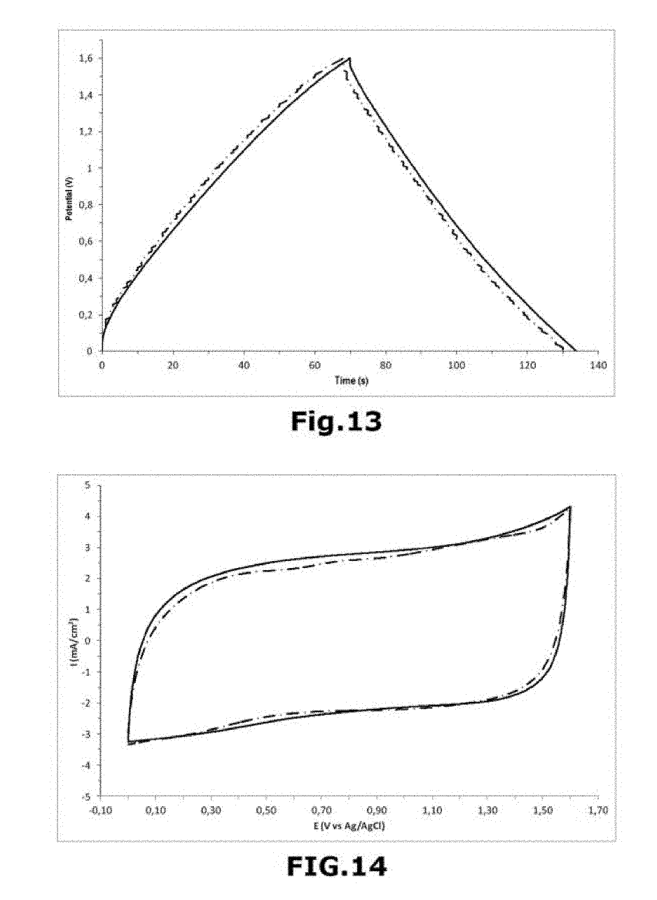

The evolution of the charge-discharge cycles as a function of time, during galvanostatic cycling of SC-1 over 1000 cycles, at a constant current density of 3 mA·cm⁻² and for a voltage of 1.6 V, is presented in FIG. 13: during the initial cycle (solid line) and during the 1000th cycle (alternating dotted line).

Measurement of the current density I (in mA/cm²) as a function of the potential applied (i.e. between 0.0 V and 0.9 V) versus the Ag/AgCl reference electrode is presented in FIG. 14, using a cycling rate of 20 mV/s, after different cycles of galvanostatic cycling: before cycling (solid line) and after 1000 cycles (alternating dotted line).

The supercapacitor SC-1 is stable over 1000 cycles with a loss of capacitance of only 1% after 1000 cycles.

1. Method for preparing a composite electrode comprising a composite material deposited on a current collector CC, said method comprising:
1) a step of functionalization of a carbon-containing agent CE with any one of the following functional groups L: carboxylic acid [—CO₂M], acyl halide [—COX], acid anhydride [—C(═O)OC(═O)—], sulphonic acid [—SO₂(OM)], sulphonic acid halide [—SO₂X], phosphonic acid dihalide [—POX₂], monoester halide of phosphonic acid [—POX(OR)], monoester of phosphonic acid [—PO(OR)(OM)], diester of phosphonic acid [—PO(OR)₂] or isocyanate [—N═C═O], with X representing a chlorine atom or a bromine atom, M representing a proton, an alkali metal cation or an organic cation and R representing a methyl or ethyl group, in order to form a functionalized carbon-containing agent CE-f, and
said method further comprises the following steps:
2) a step of preparing an aqueous or organic paste comprising the functionalized carbon-containing agent CE-f from step 1), at least one active material MA and at least one hydrophilic polymer PH comprising several alcohol functions, and
3) a step comprising bringing the aqueous or organic paste into contact with a current collector CC and thermal treatment of the aqueous or organic paste and of the current collector CC, in order to form a composite electrode comprising a composite material deposited on said current collector CC,
wherein:
said current collector CC has a surface resistance less than or equal to 50 ohms/cm², and
said composite material comprises a functionalized carbon-containing agent CE-f, at least one active material MA, and at least one crosslinked hydrophilic polymer PH-r comprising several alcohol functions and several ester functions selected from esters of carboxylic acids, esters of phosphonic acids, esters of sulphonic acids and carbamates, said crosslinked hydrophilic polymer PH-r being bound covalently to the functionalized carbon-containing agent CE-f via said ester functions.

2. Method according to claim 1, wherein the carbon-containing agent CE is selected from a carbon black, a graphite, a graphene, an SP carbon, an acetylene black, a vitreous carbon, carbon nanotubes, carbon fibres, carbon nanofibres and a mixture thereof.

3. Method according to claim 1, wherein the carbon-containing agent CE is functionalized in step 1) using a reagent T-X-L, in which:
the group T is a functional group capable of reacting with CE to form a covalent bond or a precursor functional group of a functional group capable of reacting with CE to form a covalent bond;
the group X is a conjugated spacer group;
the group L is as defined in claim 1.

4. Method according to claim 3, wherein the reagent T-X-L is a diazonium salt or a precursor of a diazonium salt.

5. Method according to claim 4, wherein L is —CO₂H or —CO₂M and T is —NH₂.

6. Method according to claim 1, wherein the active material MA is selected from oxides, phosphates, borates, activated carbons and metal alloys of the type Li_{Y}M in which 1<y<5 and M=Mn, Sn, Pb, Si, In or Ti.

7. Method according to claim 1, wherein the hydrophilic polymer PH comprising several alcohol functions has a molecular weight in the range from 5000 g/mol to 300000 g/mol.

8. Method according to claim 1, wherein the hydrophilic polymer PH comprising several alcohol functions is selected from polysaccharides, oligosaccharides and synthetic polymers comprising [—CH₂—CH(OH)—]ₙ repeating units, with n ranging from 100 to 7000.

9. Method according to claim 8, wherein the hydrophilic polymer PH is polyvinyl alcohol.

10. Method according to claim 1, wherein step 2) is carried out according to the following substeps:
2-i) preparing an aqueous or organic solution comprising from 0.5 to 30 wt % of hydrophilic polymer PH,
2-ii) preparing an aqueous or organic suspension comprising from 0.1 to 10 wt % of MA; and from 0.1 to 5 wt % of CE-f,
2-iii) mixing the aqueous or organic suspension from substep 2-ii) with the aqueous or organic solution from substep 2-i), and
2-iv) holding the resultant suspension at room temperature or heating, in order to obtain an aqueous or organic paste.

11. Method according to claim 1, wherein step 3) comprises:
3-i) a substep in which the CC is placed in a container,
3-ii) a substep in which the aqueous or organic paste obtained in step 2) is poured into the container comprising the CC, and
3-iii) a substep of thermal treatment of the container comprising the CC and the aqueous or organic paste at a temperature of at least 100° C.

12. Method according to claim 1, wherein step 3) comprises:
3-a) a substep in which the aqueous or organic paste is poured into a container,
3-b) a substep of thermal treatment of the container comprising the aqueous or organic paste at a temperature of at least 100° C.,
3-c) a substep in which the CC is placed in the container, on top of the thermally treated aqueous or organic paste, and
3-d) a substep of maintaining the thermal treatment of the container comprising the CC and the aqueous or organic paste at a temperature of at least 100° C.

13. Method according to claim 1, wherein the current collector CC is selected from a metallic material, a carbon-containing material, a silicon-based material, a textile material, a metallic material modified by a layer of carbon, of transition metal nitride or of conductive polymer and a material consisting of a layer of polymer composite and a layer of carbon-containing material.

14. Method according to claim 13, wherein the current collector CC is a material consisting of a layer of polymer composite and a layer of carbon-containing material.

15. Method according to claim 1, the current collector CC is functionalized and the method then further comprises an additional step prior to step 3), in which the CC is functionalized to form a functionalized current collector CC-f.

16. Method according to claim 1, wherein the ester functions are carboxylic acid ester functions.

17. Composite electrode comprising a composite material deposited on a current collector CC obtained by the method as defined in claim 1, wherein:
said current collector CC has a surface resistance less than or equal to 50 ohms/cm², and
said composite material comprises a functionalized carbon-containing agent CE-f, at least one active material MA, and at least one crosslinked hydrophilic polymer PH-r comprising several alcohol functions and several ester functions selected from esters of carboxylic acids, esters of phosphonic acids, esters of sulphonic acids and carbamates, said crosslinked hydrophilic polymer PH-r being bound covalently to the functionalized carbon-containing agent CE-f via said ester functions, the carbon-containing agent CE, the active material MA and the current collector CC being as defined in any one of claims 1 to 16.

18. Composite electrode according to claim 17, wherein the composite material comprises from 30 to 90 wt % of MA, from 5 to 70 wt % of CE-f, and from 5 to 50 wt % of crosslinked hydrophilic polymer PH-r.

19. Electrochemical storage system comprising a positive electrode and a negative electrode separated by an electrolyte, characterized in that at least one of the electrodes is a composite electrode obtained by the method as defined in claim 1.

20. A composite electrode as defined in claim 17, said composite electrode configured to be employed in an energy storage system, in a sensor, or a detector of gases, ions or pollutants.
